(19) United States
(12) Patent Application Publication
(10) Pub. No.: US 2006/0087856 A1
(43) Pub. Date: Apr. 27, 2006

(54) Optical axis controller

(75) Inventors: Toshio Sugimoto, Okazaki-city (JP); Koji Ishiguro, Toyoake-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/255,992

(22) Filed: Oct. 24, 2005

(30) Foreign Application Priority Data
Oct. 25, 2004 (JP) 2004-309488
Jun. 16, 2005 (JP) 2005-175955

(51) Int. Cl. B60Q 1/10

(52) U.S. Cl. 362/466

(57) ABSTRACT

An optical axis controller for a headlight of a vehicle includes a steering angle detector for detecting a steering angle of a steering wheel, a speed detector for detecting a speed of the vehicle, a navigation information reader for reading navigation information and an optical axis control device for controlling a direction of an optical axis of the headlight based on the steering angle, the speed and the navigation information. The direction of the optical axis of the headlight is determined based either on the speed and the navigation information or on the steering angle and the speed, and the determined direction of the optical axis is adapted with a controlled responsiveness.

### CROSS REFERENCE TO RELATED APPLICATION

This application is based on and claims the benefit of priority of Japanese Patent Application No. 2004-309488 filed on Oct. 25, 2004, and Japanese Patent Application No. 2005-175955 filed on Jun. 16, 2005, the disclosure of which is incorporated herein by reference.

### FIELD OF THE INVENTION

The present invention generally relates to. an optical axis controller for controlling an optical axis of a headlight of a vehicle based on a steering angle of a steering wheel.

### BACKGROUND OF THE INVENTION

An optical axis controller for controlling a direction of an optical axis of a headlight of a vehicle is disclosed in U.S. Pat. Document No. 6,671,640. The optical axis controller in this disclosure swivelingly controls the optical axis of the headlight in horizontal directions based on a steering angle of a steering wheel. According to the disclosure, responsiveness of the swiveling motion of the optical axis of the headlight is determined by a rotation speed of the steering wheel.

However, the swiveling motion of the optical axis in the above disclosure has a delay in principle in its response because of the detection time and calculation time for the rotation angle and the rotation speed of the steering wheel. Further, the swiveling motion has to be carefully controlled for satisfactorily meeting driver's demand such as secured and stable visibility of a road in a headlight-lit space of a vehicle or the like. That is, the driver feels awkwardness when responsiveness (e.g., response speed) of the swiveling motion of the optical axis is either too quick or too slow compared to a driving operation such as the rotation angle of the steering wheel and/or the road condition ahead of the vehicle.

### SUMMARY OF THE INVENTION

In view of the above-described and other problems, the present invention provides an optical axis controller that has a suitable responsiveness when it controls an optical axis of a headlight in a swiveling motion. The optical axis controller controls the optical axis of the headlight without compromising visibility of the driver nor causing awkwardness.

The optical axis controller of the present invention has the advantage that the swiveling motion of the optical axis of the headlight is predictably determined prior to a rotating operation of the steering wheel by a driver of a vehicle. Suitable responsiveness of the swiveling motion is calculated and determined based on the speed of the vehicle and information on a road ahead of the vehicle derived from a navigation system. In this manner, the optical axis of the headlight is swivelingly controlled in a horizontal direction for suitably lighting the road. The responsiveness of the swiveling motion is further adjusted when the steering wheel is actually rotated by the driver of the vehicle. The responsiveness of the swiveling motion for the adjustment is controlled based on the difference of the prediction and the actual condition of driving operation. In this manner, the swiveling motion of the optical axis of the headlight is suitably and comfortably controlled for the safety of driving operation without delay.

The responsiveness of the swiveling motion of the optical axis is controlled by selectively changing filter functions for calculation of swiveling angle of the optical axis based on parameters such as a vehicle speed, a steering angle, and the like. That is, a relatively large swiveling angle of the optical axis is swiftly adapted, and a relatively small swiveling angle is less swiftly adapted in terms of responsiveness in response to the operation of the steering wheel or in response to the information on the road ahead of the vehicle by using different filter functions. In this manner, the swiveling angle of the optical axis of the headlight is suitably controlled for the ease and safety of driving operation by the driver of the vehicle.

The swiveling of the optical axis is suppressed when the rotation angle of the steering wheel is around the neutral point (i.e., zero degree). In this manner, vibration and/or small irritating motion of the optical axis caused by, for example, the play of the steering wheel is prevented.

### BRIEF DESCRIPTION OF THE DRAWINGS

Other objects, features and advantages of the present invention will become more apparent from the following detailed description made with reference to the accompanying drawings, in which:

FIG. 1 shows a block diagram of an optical axis controller in an embodiment of the present invention;

FIG. 2 shows an illustration of light emitted from a headlight of a vehicle; and

FIG. 3 shows a flowchart of a swiveling motion control process executed in a CPU of the optical axis controller (ECU).

### DETAILED DESCRIPTION OF THE PREFERRED EMBODIMENTS

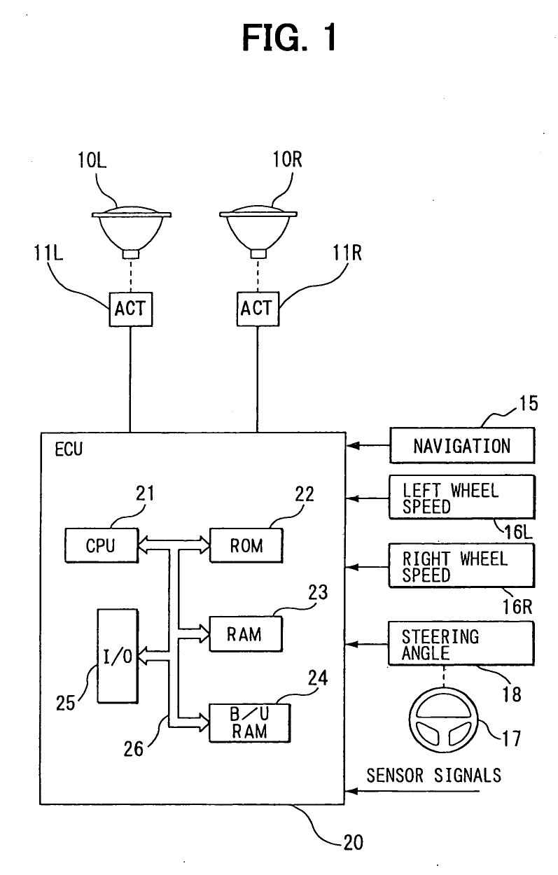

FIG. 1 shows a block diagram of an optical axis controller in an embodiment of the present invention.

In the first embodiment, as shown in FIG. 1, left and right headlights 10L, 1OR are provided on a front side of a vehicle. Actuators 11L, 11R for adjusting an optical axis direction are connected to the left and right headlights 10L, 10R respectively. An electric control unit (ECU) 20 is provided for controlling the optical axis direction of the vehicle headlight. It includes a well-known central processing unit (CPU) 21, a read only memory (ROM) 22, a random access memory (RAM) 23, a backup RAM 24, an input/output circuit 25 and a bus line 26 which connects the above devices. The CPU 21 performs various operations and processing. The ROM 22 stores a control program, a control characteristic of the optical axis direction of the left and right headlights 10L, 1OR and the like. The RAM 23 stores various data.

Output signals from a well-known navigation system 15, a left wheel speed sensor 16L for detecting a left wheel speed, a right wheel speed sensor 16R for detecting a right wheel speed, a steering angle sensor 18 for detecting a steering angle STA of a steering wheel 17 which a driver operates and signals from various sensors are inputted to the ECU 20. The ECU 20 outputs signals to the actuators 11L, 11R to adjust the optical axis direction of the left and right headlights 10L, 10R.

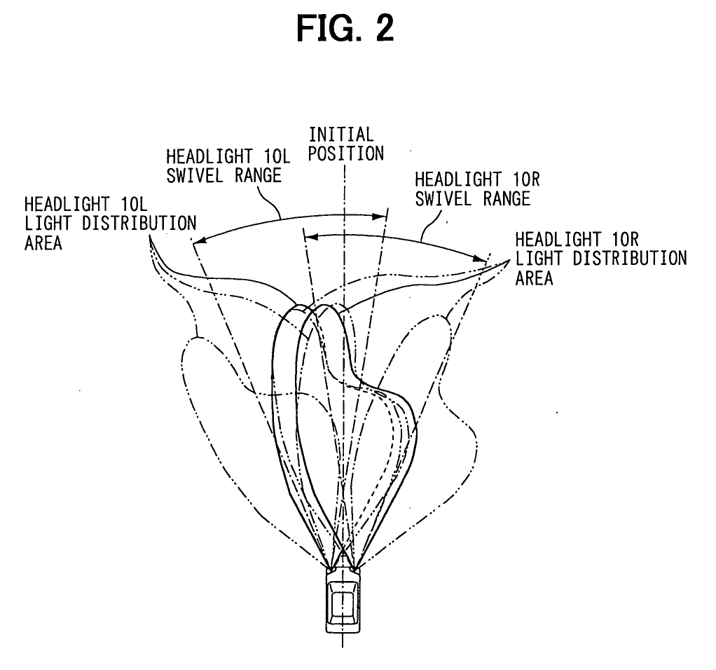

As shown in FIG. 2, a light distribution area of the left and right headlights 10L, 10R is adjusted in a left or right direction within a swiveling range, according to a steering in a left or right direction from a neutral point of the steering wheel 17. The swiveling range is set so that front visibility of the driver is not blocked and visibility in left and right directions is ensured while the driver operates the steering wheel 17. Therefore, the swiveling angle of the headlight 10L in the left direction is set to be larger than that of the headlight 10R when the steering wheel 17 is turned toward the left direction. To the contrary, the swiveling angle of the headlight 10R in the right direction is set to be larger than that of the headlight 10L in the right direction when the steering wheel 17 is turned toward the right direction.

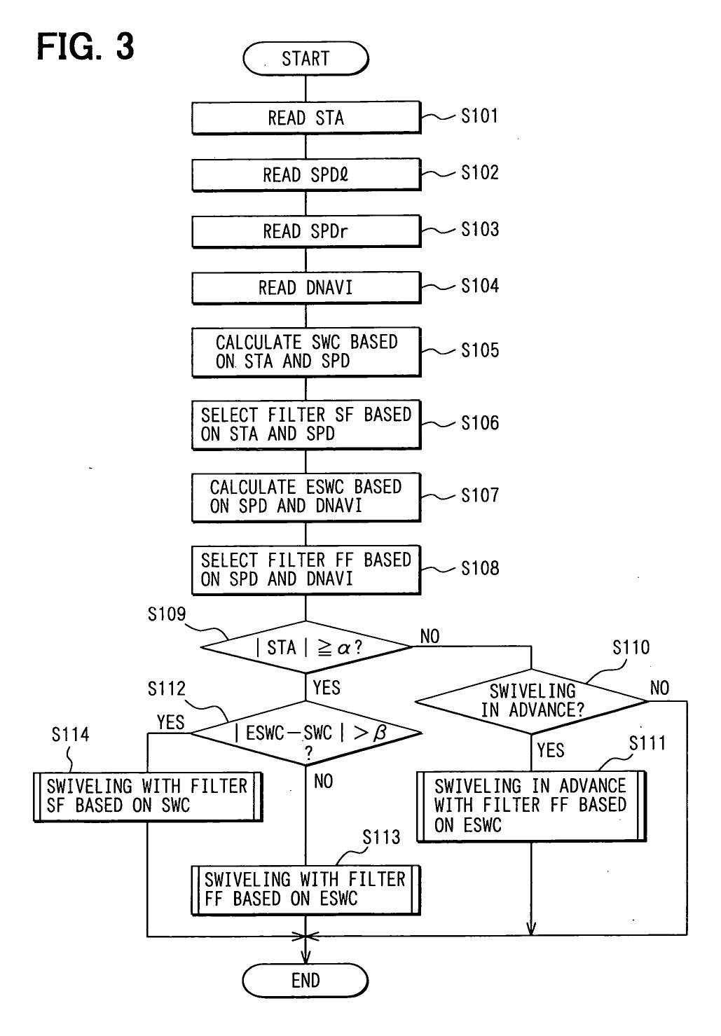

A swivel control process shown as a flowchart in FIG. 3 is repeated every predetermined control time. In step S101, the steering angle STA, which is detected by the steering angle sensor 18, is read. In step S102, a left wheel speed SPDI (es pee dee el) detected by the left wheel speed sensor 16L is read. At step S103, and a right wheel speed SPDr detected by the right wheel speed sensor 16R are read. In step S104, a forward road information DNAVI is read from the navigation system 15.

In step S105, a swivel control angle SWC is determined according to the steering angle STA read at step S101 and a vehicle speed SPD based on the left wheel speed SPDI read at step S102 and the right wheel speed SPDr read at step S103. In this case, the swivel control angle SWC is set to 0 (zero) degree when the absolute value of the steering angle STA is less than a predetermined value α regardless of the vehicle speed SPD.

In step S106, a plurality of control characteristics stored in the ROM 22 is used to select a filter SF that has a suitable responsiveness for a normal swivel control corresponding to the steering angle STA and the vehicle speed SPD.

In step S107, an estimated swivel angle ESWC is determined according to the vehicle speed SPD and the forward road information DNAVI read in step S104. In this case, the estimated swivel control angle ESWC is set to 0 (zero) degree when the forward road information DNAVI indicates that the road is straight.

In step S108, a plurality of control characteristics stored in the ROM 22 are used to select a filter FF that has a suitable responsiveness for a prior swivel control corresponding to the vehicle speed SPD and the forward road information DNAVI.

In step S109, the absolute value of the steering angle STA is compared with the predetermined angle α. That is, the steering angle STA is determined whether it is equal to/greater than the predetermined angle α. The angle a defines α non-responsive range around the neutral point of the steering sensor 16. The angle α is defined in order to suppress vibrations or a shaking motion of the optical axis of the headlights 10L, 1OR caused by the play and/or a delicate maneuver of the steering wheel 17.

The swivel control process proceeds to step S110 when the steering angle STA is smaller than α. That is, in this case, the steering angle STA of the steering wheel 17 under operation of the driver is regarded as 0 degree.

In step S110, necessity of the prior swivel control, i.e., the swivel control prior to a steering control is determined. That is, the swivel control process determines whether the swivel control prior to turning the steering wheel 17 based on the estimated swivel angle ESWC calculated by using the vehicle speed SPD, the forward road information DNAVI and the like in step S107 is required. The swivel control process proceeds to step S111 when the prior swivel control is required. In step S111, the prior swivel control based on the estimated swivel angle ESWC processed with the filter FF is executed before the conclusion of the swivel control process. The swivel control process concludes without having any further step when the prior swivel control is not required.

The prior swivel control in the present embodiment calculates and applies the estimated swivel angle ESWC by using the vehicle speed SPD and the forward road information DNAVI in the following manner. That is, the radius of curvature of a portion of the road ahead of the vehicle is continuously calculated by using the vehicle speed SPD and the forward road information DNAVI, and the swiveling motion of the optical axis of the headlights 10R, 10L horizontally to the right or left is controlled prior to turning of the steering wheel 17 by using the estimated swivel angle ESWC processed with the filter FF for applying a suitable responsiveness.

The swivel control process proceeds to step S112 when the absolute value of the steering angle is greater than the predetermined angle α. In step S112, the absolute value of the difference between the estimated swivel angle ESWC calculated in step S107 and the swivel angle SWC calculated in step S105 is compared with a predetermined value β. The predetermined value β for the comparison defines an acceptable tolerance of the difference between the ESWC and the SWC.

The swivel control process proceeds to step S113 when the absolute value of the difference between the ESWC and the SWC is equal to or smaller than the predetermined value β. In step S113, the swivel control is executed based on the estimated swivel angle ESWC processed with the filter FF for applying a suitable responsiveness before concluding the swivel control process.

The swivel control process proceeds to step S114 when the absolute value of the difference between the ESWC and the SWC is greater than the predetermined value β. In step S114, the swivel control is executed based on the swivel angle SWC processed with the filter SF for applying a suitable responsiveness before concluding the swivel control process.

The estimated swivel angle ESWC is adjusted toward the swivel angle SWC when the absolute value of the difference between the ESWC and the SWC is greater than the predetermined value β. The adjustment from the ESWC to the SWC is executed in an appropriately responsive manner in order to avoid a dizziness or the like to the driver caused by a sudden change in the direction of the optical axis of the headlights 10L, 10R.

Merely for the sake of thoroughness, it should be pointed out that the difference between the estimated swiveling angle ESWC and the swiveling angle SWC is adjustably controlled in a no-dizziness-causing manner in the present invention. That is, quick adjustment of the swiveling angle from, for example, 10 degrees to 5 degrees is prevented by selectively using a filter function for controlling the adjustment movement of the swiveling angle. In this manner, quick change of headlight-lit area that causes dizziness is prevented, and thus the optical axis of the headlight is suitably directed to a traveling direction of the vehicle without delay.

It should also be pointed out that the filter functions used in the adjustment of the swiveling angle serves as a “damping factor“ of the swiveling motion of the optical axis. That is, the swiveling motion of the optical axis of the headlights 10L, 10R in the course of application of the calculated swiveling angle is smoothly controlled by using the filter function particularly at the beginning and at the end of the swiveling motion. In this manner, the swiveling angle of the optical axis is suitably controlled for the ease and the safety of the driving operation.

It should also be pointed out that the steering angle sensor 18 has a non-responsive area around the neutral point (steering angle of zero degree). In this manner, a small vibration of the optical axis of the headlights 10L, 10R caused by the play of the steering wheel 17 around the neutral point is prevented for an improved drivability.

Although the present invention has been fully described in connection with the preferred embodiment thereof with reference to the accompanying drawings, it is to be noted that various changes and modifications will become apparent to those skilled in the art.

For example, swiveling headlights may be disposed separately from fixed (not-swiveling) headlights for achieving the same effect of the invention as the above-described embodiment.

Such changes and modifications are to be understood as being within the scope of the present invention as defined by the appended claims.

What is claimed is:

1. An optical axis controller for a headlight of a vehicle comprising:
a steering angle detector for detecting a steering angle of a steering wheel;
a speed detector for detecting a speed of the vehicle;
a navigation information reader for reading navigation information; and
an optical axis control device for controlling a direction of an optical axis of the headlight based on the steering angle, the speed and the navigation information,
wherein the direction of the optical axis of the headlight is determined as an first direction based on the speed and the navigation information or as a second direction based on the steering angle and the speed, and
at least one of the first direction and the second direction of the optical axis is adapted with a controlled responsiveness.

2. The optical axis controller according to claim 1,
wherein a first controlled responsiveness is determined by using the speed and the navigation information, and
a second controlled responsiveness is determined by using the steering angle and the speed.

3. The optical axis controller according to claim 2,
wherein the first direction is adapted as the optical axis with the first controlled responsiveness when the steering angle is smaller than a first predetermined value,
the first direction is adapted as the optical axis with the first responsiveness when the steering angle is greater than the first predetermined value and difference between the first direction and the second direction is smaller than a second predetermined value, and
the second direction is adapted as the optical axis with the second responsiveness when the steering angle is greater than the first predetermined value and difference between the first direction and the second direction is greater than the second predetermined value.

4. The optical axis controller according to claim 1,
wherein the steering angle detector has a non-responsive area around a neutral point of the steering angle.
